(19) United States
(12) Patent Application Publication
(10) Pub. No.: US 2007/0213044 A1
(43) Pub. Date: Sep. 13, 2007

(54) Wireless nanoamp resolution galvanostat/potentialstat

(75) Inventors: Daniel Steingart, Berkeley, CA (US); Andrew Redfern, Berkeley, CA (US); Christine Ho, Berkeley, CA (US); Chris Kumai, Berkeley, CA (US); James W. Evans, Piedmont, CA (US)

Correspondence Address: Trellis Intellectual Property Law Group, PC, 1900 EMBARCADERO ROAD, SUITE 109, PALO ALTO, CA, 94303, US

(73) Assignee: The Regents of the University of California, Oakland, CA (US)

(21) Appl. No.: 11/713,464

(22) Filed: Mar. 1, 2007

Related U.S. Application Data
(60) Provisional application No. 60/777,979, filed on Mar. 1, 2006.

(51) Int. Cl. H04M 1/00

(52) U.S. Cl. 455/423; 455/553.1

(57) ABSTRACT

In one embodiment, a wireless measurement device is provided. A wireless transceiver is configured to communicate with a base station through a wireless medium to receive configuration information. The wireless transceiver outputs a signal for use in measuring a potential or current based on the configuration information. A circuit is configured to function as a galvanostat and can receive the signal and achieve a desired current using the signal. A potential of a test cell is then measurable using the current. Also, the circuit is configured to function as a potentiostat and can achieve a desired potential using the signal. The current of the test cell is then measurable using the potential. The wireless transceiver transmits the measured potential or current wirelessly to a second wireless transceiver.

### CROSS REFERENCES TO RELATED APPLICATIONS

This application claims priority from U.S. Provisional Patent Application Ser. No. 60/777,979, entitled “WIRELESS NONAMP RESOLUTION GALVANOSTAT”, filed on Mar. 1, 2006, which is hereby incorporated by reference as if set forth in full in this application for all purposes.

### BACKGROUND

Particular embodiments generally relate to galvanostats/potentiostats and more specifically to a wireless galvanostat/potentiostat.

The academic realization and the commercial hope of “smart dust” devices, or a small (less that one cubic centimeter) wireless sensor nodes (WSNs) has led to a massive effort for microbatteries, both primary and secondary. Characterizing the expected life of an electrochemical energy cell, both in terms of time for a single discharge and number of cycles, is a critical aspect of both battery and device development. Modern microelectronics draw energy on a constant current basis, thus galvanostatic studies are the preferred method for discharging and cycle testing cells. WSNs are a particularly interesting case: 99% of the time they are in a low power state (˜100 μA or less), but when activated, they require short pulses of up to 50 mA. Based on a centimeter square footprint, this translates to current densities of 120 A/mˆ2.

While numerical modeling provides a starting point, the high pulse currents and fabrication techniques lead to unique cells, the performance and life of which are best predicted by rigorous electrochemical cycling. Commercial galvanostats with sub-microampere resolution, however, cost between $5,000 and $10,000 a channel. Cycling tests may take days or even weeks. Thus testing cells through serial throughput is not time effective but the cost of testing multiple cells in parallel is unrealistic for most academic and industrial entities. In addition, many cells are tested initially in argon ambient, it is difficult using conventional galvanostats to test more than five or six cells in a standard glove box. The glove box is hermetically sealed to ensure accurate operation of the cells. Thus, holes need to be drilled in the glovebox to include wires to send readings from inside the glovebox to the outside environment.

### SUMMARY

Embodiments of the present invention generally relate to wireless galvanostats/potentiostats. In one embodiment, a wireless galvanostat/potentiostat that is used to power cells is used to test the cells. The wireless galvanostat/potentiostat has good current resolution and a small footprint. Embodiments of the present invention may be inexpensive and cost substantially around $100 dollars a channel to build.

In one embodiment, a wireless measurement device is provided. A wireless transceiver is configured to communicate with a base station through a wireless medium to receive configuration information. The wireless transceiver outputs a signal for use in measuring a potential or current based on the configuration information. A circuit is configured to function as a galvanostat and can receive the signal and achieve a desired current using the signal. A potential of a test cell is then measurable using the current. Also, the circuit is configured to function as a potentiostat and can achieve a desired potential using the signal. The current of the test cell is then measurable using the potential. The wireless transceiver transmits the measured potential or current wirelessly to a second wireless transceiver.

In one embodiment, the wireless measurement device includes four 12-bit analog to digital converters, two 12-bit digital to analog converters, four general I/O pins, 2.5V (nominal) VCCs, a 2.4 GHz radio, and 10 KB RAM, and 1 MB flash memory. It will be understood that variations of these components may be appreciated.

In one embodiment, a wireless measurement device is provided. The device comprises: a wireless transceiver configured to communicate with a base station through a wireless medium to receive configuration information. The wireless transceiver outputs a signal for use in measuring a potential or current based on the configuration information. A circuit is configured to receive the signal and achieve a desired current using the signal, wherein a potential of a test cell is measurable using the current. Also, the circuit is configured to achieve a desired potential using the signal, wherein a current of the test cell is measurable using the potential. The wireless transceiver transmits the measured potential or current wirelessly to a second wireless transceiver.

A system comprising a first wireless transceiver configured to communicate with a base station through a wireless medium to receive configuration information is provided. The wireless transceiver outputs a signal for use in measuring a potential or current based on the configuration information. A circuit is configured to receive the signal and achieve a desired current or potential using the signal, wherein a potential or current of a test cell is measurable using the current or potential. A second wireless transceiver is configured to receive the potential or current measured from the first wireless transceiver through the wireless medium.

A further understanding of the nature and the advantages of particular embodiments disclosed herein may be realized by reference of the remaining portions of the specification and the attached drawings.

### BRIEF DESCRIPTION OF THE DRAWINGS

FIG. 1 details the overall wireless measurement system according to one embodiment.

FIG. 2 depicts a circuit design for the circuit according to one embodiment.

FIG. 3 illustrates the scaling possibilities of the wireless measurement system according to one embodiment.

FIG. 4 depicts a more detailed example of the system for galvanostatic control according to one embodiment.

FIG. 5 depicts a more detailed example of the system for potentiostatic control according to one embodiment.

### DETAILED DESCRIPTION OF EMBODIMENTS

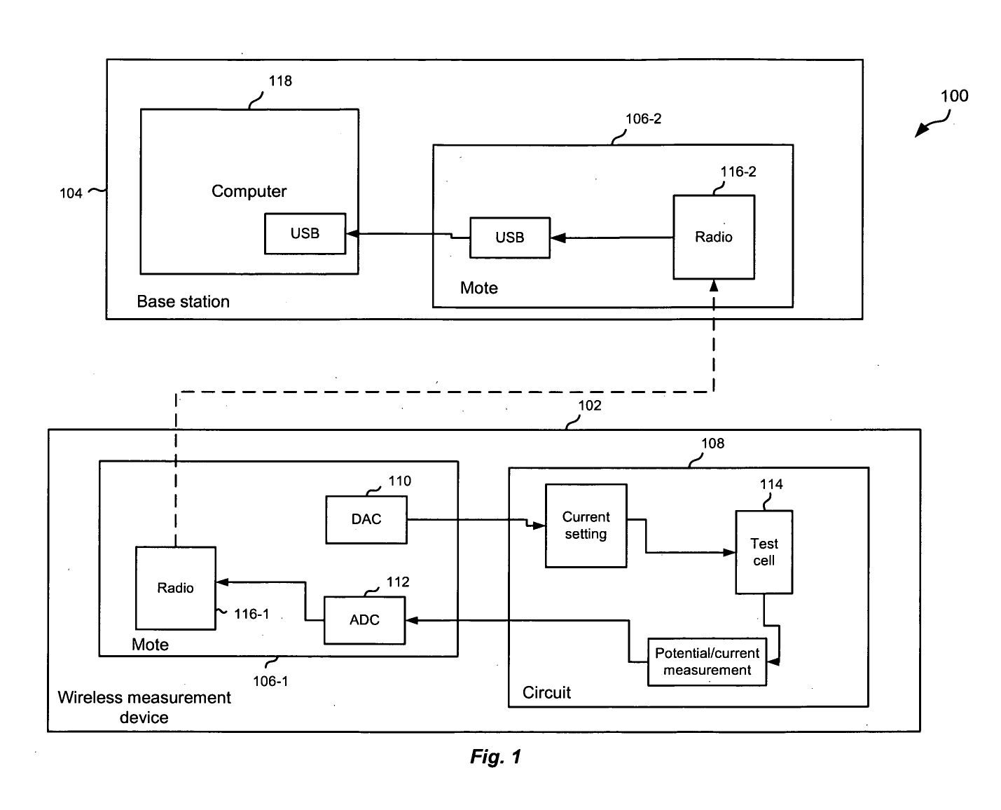

FIG. 1 details the overall wireless measurement system 100 according to one embodiment. As shown, a base station 104 unit and a wireless measurement device 102 are provided. It will be understood that any number of base stations 104 and wireless measurement devices 102 may be included in system 100. Wireless measurement device 102 may function as a galvanostat or potentiostat. A galvanostat may be an electronic instrument that controls the current through an electrochemical cell at a preset value. The galvanostat is a control and measuring device capable to keep constant the current flowing through a test cell in coulometric titrations, disregarding changes in the load itself. In portions of the description, galvanostats may be described, but it will be understood that potentiostats may also be provided in place of a galvanostats. A potentiostat is a control and measuring device that, in a test cell, keeps the potential of the test cell at a constant level respect to the reference potential. The electric circuit controls the potential across the test cell by sensing changes in its resistance, varying accordingly the current supplied to the system: a higher resistance will result in a decreased current, while a lower resistance will result in an increased current, in order to keep the voltage constant.

The wireless measurement device 102 includes a mote 106 and a circuit 108. The mote 106 is a wireless transmitter configured to communicate wirelessly with a device. The mote 106 may be configured to use sensors to monitor physical or environmental conditions. The mote 106 may be programmed to access one or more digital to analog (DAC 110) channels provided by an on board microcontroller, such as a Texas Instruments MSP430 microcontroller. These DAC 110 channels may provide 12 bits (4095) levels of potential control from 0 V to 1.5 V or 2.5 V (programmable). The signal from DAC 110 is leveraged in circuit 108 to set the current that is used to measure the potential across a test cell 114 or to set the potential to measure the current across the test cell.

An onboard analog to digital converter (ADC) 112 (e.g., 12 bit ADC) of the mote 106 is used to measure the potential of the cell. The current can be interrupted (e.g., 400 μS) briefly while measuring potential to correct for IR loss while still allowing measurement of cell relaxation. The potential measurement is sent from the circuit 108 to the ADC 112. The analog signal is then converted into a digital signal that can be stored or transmitted wirelessly.

The mote 106-1 may be configured to send potential readings to a mote 106-2. A radio 116-1 receives a digital signal of the potential measurement and transmits it wirelessly to the radio 116-2. For example, the wireless measurement device 102 may be placed inside a glove box or any other object, such as a room, test area, etc. The glove box is a sealed container that is designed to allow one to manipulate objects while being in a different atmosphere from the object. The glove box allows a user to manipulate objects, such as a test cell 114 in an inert atmosphere. Because the atmosphere must be maintained in the glove box, not having to modify the glove box is important. For example, if a wired galvanostat is used, then holes must be drilled in the glove box to allow the wires to be connected from the galvanostat to the base station 102. However, holes do not have to be drilled because the wireless measurement device 102 transmits potential measurements wireless. In other embodiments, the wireless galvanostat does not need to be placed inside a sealed glove box but may be used in any area. Also, although the transmission may be wireless, it may also include wired links. For example, the initial transmission from the radio 116-1 may be wireless but then once transmitted outside of the glove box, a wired connection may be used.

When the radio 116-2 receives the potential measurements, it can store the measurements or transmit them to a computer 118. For example, a USB connection may be used to send the measurements for storage on computer 118. The computer 118 may also display the results of the measurements.

A client is provided in computer 118, e.g., in Java, to control the current on the mote 106 and log incoming data. The mote 106 may be calibrated from the external interface, but cycling control may occur using the motes's logic as opposed to a remote computer 118, which substantially increases the response time while minimizing cycling overshoot.

Accordingly, a signal from the mote 106-1 is used to measure the potential across a test cell 114. The signal is accurate and allows very small currents to be produced in circuit 108. This allows very small test cells 114 to be tested. The size of a test cell is scaled to the amount of current it conducts. Thus, being able to generate small currents in the circuit 108 is important. Further, the circuit 108 uses the signal outputted by the mote 106, which allows the size of the circuit 108 to be reduced. In one embodiment, assembled, with batteries, the wireless measurement device 102 measures substantially 15 cm by 12 cm by 9 cm. Thus, a small size is provided with high resolution. Further, the circuit 108 may be produced at a very low cost.

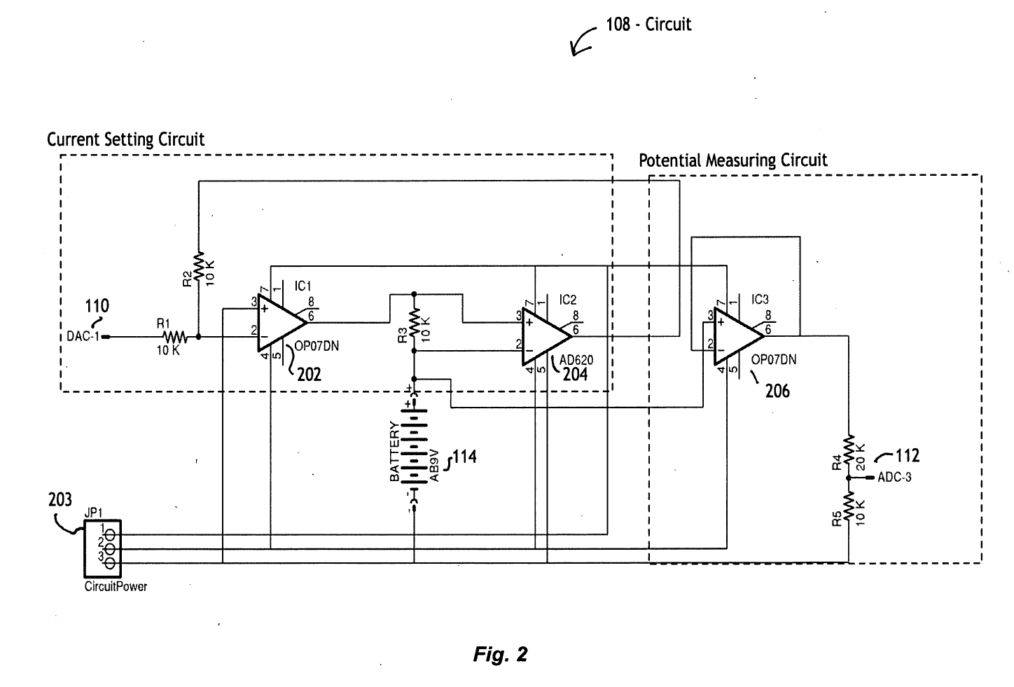

FIG. 2 depicts a circuit design for the circuit 108 according to one embodiment. Although certain resistance values and model numbers are shown, it will be understood that other values, model numbers, and components may be used. An input at DAC-1 receives a signal from DAC 110 of mote 106. The signal may have a voltage, which may be 0-1.5 Volts with a 12 bit accuracy. The signal is input into a first op amp 202. A resistor R1 and a resistor R2 provide a unity gain buffer. That is, whatever current is found at the output of the test cell 114 is matched here using R1 and R2.

A second op amp 204 provides a feedback loop. The feedback loop sends the current produced back for input into op amp 202. Although op amps are described it will be understood that other components may be used to generate the current.

In one embodiment, the DAC 110 has a discrete resolution in steps of 0.4 mV or 0.6 mV. By placing the two poles against each other, negative and positive potentials are achieved. The circuit 108 then translates this potential range linearly to a desired current at R3. The current is set using Ohm's law: I=V/R.

In FIG. 2, a resistor R3 is used to set the current. It follows that a resistor of 100Ω gives a maximum range of 25 mA for at maximum potential of 2.5 V, and based on the 12 bit DAC 110 the minimum current step size is 6 μA. Range is traded linearly for resolution; a 10 MΩ resistor achieves a maximum current of 250 nA and a theoretical resolution of 6 pA to 100 pA. In one embodiment, the galvanostat's range is enabled from 1 nA to 15 mA through a six pole-six resistor switch.

The common collector voltage (VCC) on the mote 106 may be nominally 2.5 V, so a voltage divider circuit may be added to increase the range of potential measurement. Again a six pole-six resistor switch is used to extend the 12 input bits from 2.5 V to 9 V. The potential can be measured up to substantially 20 Hz, and is scaled using:
Vout=Vin*R2/(R1+R2)

Where R1 lies between the cell and the ADC 112 and R2 is between the ADC 112 and ground. Vin is the actual potential of the test cell 114, Vout is the scaled potential the ADC 112 reads. For example, the potential may be read at point ADC-3. This reading is sent to ADC 112, which can convert the reading to a digital signal.

The circuit 108 may be powered by two 2500 mAh 12 volt battery packs 208 in series. A lead placed between them provides a common ground that allows for positive and negative currents. The DC power source may provide cleaner output currents than a converter AC line in some cases. Also, in one embodiment, with the 2500 mAh battery packs, the mote 106 can run for up to two weeks at a 1 Hz sampling rate. A larger capacity pack can be added easily to extend experiment life. A USB power source may also be provided instead of a battery.

The circuit 108 may also be used as a potentiostat that can measure the current in one embodiment. The circuit 108 controls the potential across the test cell 114 by sensing changes in its resistance and varying accordingly the current supplied to the circuit 108. Thus, a higher resistance R4 and R5 will result in a decreased current, while a lower resistance will result in an increased current, in order to keep the voltage constant. The voltage at DAC-1 is may be varied to achieve a potential at ADC-3. The voltage may be varied using software in the mote 106 or the computer 118. As the potential is varied, the current through test cell 114 may be measured. The current of the test cell 114 can then be measured for the potential achieved at ADC-3. The current from the point ADC-3 is sent to ADC 112, which can then convert the current measurement to a digital signal. The current is measured by measuring the applied voltage on the DAC and dividing by R3.

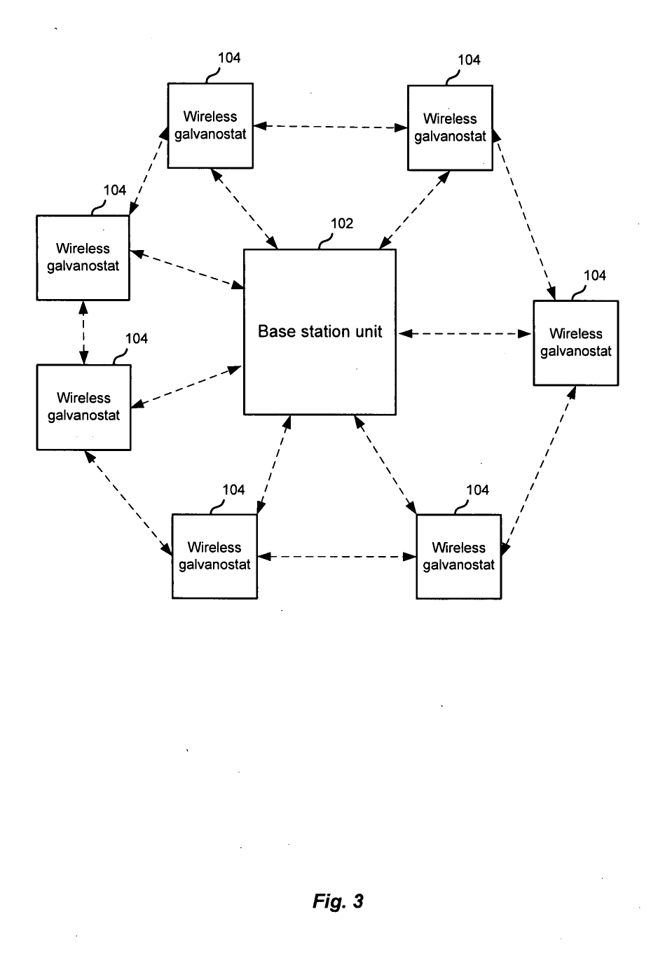

When a wireless measurement device 102 is placed inside of a glove box, a reliable communications link is provided. For example, 20 meters is realizable in one embodiment. Using mesh networking this range can be extended with repeaters if necessary. Using software, such as the TinyOS Serial Forwarder software, a computer can also act as a repeater. FIG. 3 illustrates the scaling possibilities of the wireless measurement system 100 according to one embodiment. As shown, multiple wireless measurement devices 102 may be connected to a base station. This provides a mesh network of wireless measurement devices 102, which can communicate among themselves. This network may be formed on its own using the wireless measurement devices 102. The base station 104 also listens for signals from wireless measurement devices 102. When a signal is found, the wireless measurement device 102 is able to connect to the base station. This provides scalability.

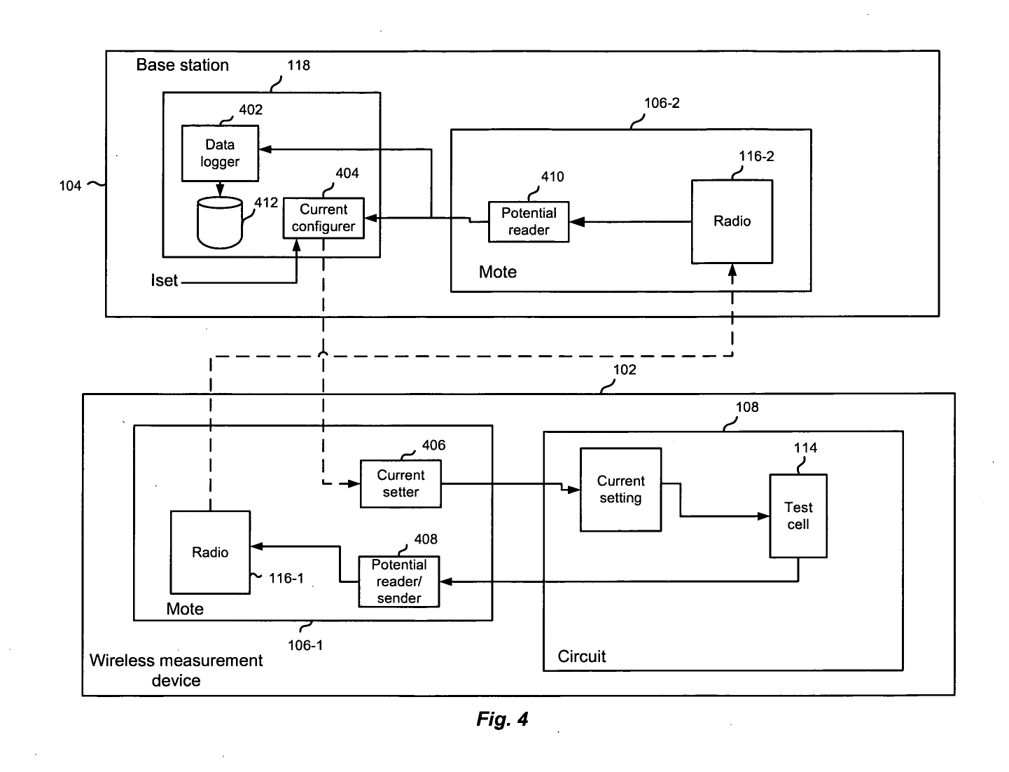

FIG. 4 depicts a more detailed example of system 100 for galvanostatic control according to one embodiment. Components of system 100 may be configured using software, hardware, or any combination thereof. A current, Iset, may be configured. For example, the current may be received from a user. Also, the current may be set automatically. The current in circuit 108 at resistor R3 will be set to be substantially equal to Iset. Also, a period to measure the potential may be set.

A current configurer 404 receives the current setting and sends it to mote 106-1. A current setter 406 is configured to set the current in circuit 108. For example, a voltage is outputted at ADC 110 that sets the current at resistor R3 to the desired current, Iset.

A potential reader/sender 408 reads the potential from circuit 108. Current configurer 404 can relax the test cell 114 such that the potential can be measured during the relaxation period. For example, the reading may be at ADC-3 during the period set. Potential reader/sender 408 then sends the reading to mote 106-2 through radio 116-1.

A potential reader 410 measures the potential sent and sends it to computer 104. A data logger 402 is configured to store the potential reading in storage 412. Also, current configurer 404 may adjust the current based on the potential readings. For example, many batteries and electrochemical systems require that constant potential be applied to obtain the desired charging/reaction.

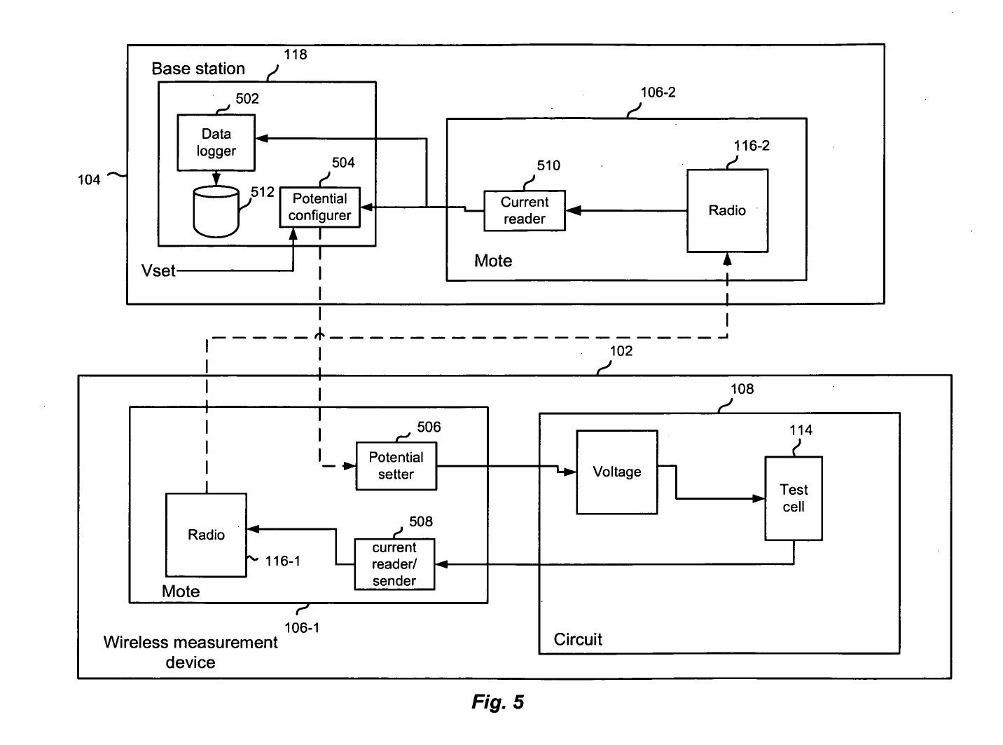

FIG. 5 depicts a more detailed example of system 100 for potentiostatic control according to one embodiment. Components of system 100 may be configured using software, hardware, or any combination thereof. A current, Iset, may be configured. For example, a voltage Vset may be received from a user and used to set the current. Also, the voltage may be set automatically. The current Iset is set such that the voltage can be used to set a potential using circuit 108. Also, a period to measure the current may be set.

A potential configurer 504 receives the voltage setting and sends it to mote 106-1. A potential setter 506 is configured to set the potential in circuit 108. For example, a voltage is outputted at ADC 110 that sets the voltage at ADC-3 to the desired voltage.

A current reader/sender 508 reads the current from circuit 108. Potential configurer 404 can relax the test cell 114 to measure the current during the relaxation period. For example, the current is read as the potential across known resistance R3. Potential reader/sender 408 then sends the reading to mote 106-2 through radio 116-1.

A current reader 510 measures the current sent and sends it to computer 104. A data logger 502 is configured to store the current reading in storage 512. Also, potential configurer 504 may adjust the current based on the current readings. For example, if the read voltage V>Vset, then the current Iset is decreased, but if the read voltage V<Vset, then the current Iset is increased. The current Iset is used to adjust the voltage, Vset.

Accordingly, galvanostat and potentiostat control can both be provided by system 100.

Applications for the Wireless Measurement Device

The wireless measurement device 102 may be used in many applications. As discussed above, the wireless measurement device 102 may be used in a glovebox to test the performance of air-sensitive batteries and capacitors that have not been hermetically sealed.

The wireless measurement device 102 may be further used to test conductivity of ionically conductive solutions, either inside or out of a glove box.

The wireless measurement device 102 can function as a wireless potentiostat, when combined with a three electrode system, and can be used to detect ionic species in a liquid medium (for example, heavy metals in a stream).

Experimental Results

A selection of resistors of known value may be used to test the IR measuring abilities of the wireless measurement device 102. A selection of capacitors may be used to test the cycling ability of the wireless measurement device 102 at large and small currents.

The current interrupt feature is software controlled, so calibration is done against resistors of known value. The accuracy of the potential reading across the resistor increases directly with an increase in applied current, due to:
R=V/I

Thus, “I” should be chosen to optimize the ADC 112 range. Table I shows the accuracy of the wireless measurement device 102 measuring various resistors.

TABLE I
Resistance Test Accuracy

| | Wireless measurement |
|---|---|
| Resistor Rating | device 102 Reading |
| 1 kΩ | 1.1 kΩ ± 2% |
| 22 kΩ | 21.5 kΩ ± 2% |
| 100 kΩ | 99.8 kΩ ± 2% |

Small capacitors may be used to test of the cycling response of a galvanostat 102. The wireless measurement device 102 may be programmed to cycle 1 V and 4 V at absolute values of 1 μA, 10 μA and 100 μA. In one embodiment, the accuracy of the measurement increased as applied current decreased. Table 2 shows the accuracy of measurement of various capacitors tested at different applied currents.

TABLE II
Type Table Name Here.

| Capacitor | Wireless measurement | Wireless measurement |
|---|---|---|
| Rating | device 102 at 1 μA | device 102 at 100 μA |
| 10 μF | 9.9 μF ± 2% | 10.2 μF ± 5% |
| 200 μF | 201 μF ± 3% | 205 μF ± 5% |
| 3700 μF | 3650 μF ± 1% | 3750 μF ± 3% |

Accordingly, a small wireless measurement device 102 with high resolution is provided. The wireless measurement device 102 may be built for under $100 in some embodiments and proven to work from inside a glove box at sufficient distances in a laboratory. Additional wireless measurement devices 102 can be added to create more channels.

Although the description has been described with respect to specific embodiments thereof, these embodiments are merely illustrative, and not restrictive of the invention. For example, a potentiostat variation of the wireless measurement device 102 with AC impedance capability may be provided.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, an and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope, as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated for carrying out this invention, but that the invention will include any and all particular embodiments and equivalents falling within the scope of the appended claims.

We claim:

1. A wireless measurement device comprising:
a wireless transceiver configured to communicate with a base station through a wireless medium to receive configuration information, the wireless transceiver outputting a signal for use in measuring a potential or current based on the configuration information; and
a circuit configured to receive the signal and achieve a desired current using the signal, wherein a potential of a test cell is measurable using the current or wherein the circuit is configured to achieve a desired potential using the signal, wherein a current of the test cell is measurable using the potential,
wherein the wireless transceiver transmits the measured potential or current wirelessly to a second wireless transceiver.

2. The measurement device of claim 1, wherein the wireless transceiver comprises a digital to analog converter (DAC) configured to provide the signal of a voltage value for achieving the desired current.

3. The measurement device of claim 1, wherein the wireless transceiver comprises an analog to digital converter (ADC) configured to measure the potential of the test cell.

4. The measurement device of claim 1, further comprising:
a first op amp configured to receive the signal;
a second op amp configured to provide feedback to the first op amp; and
a resistor configured to generate a current using the signal for input into the test cell to allow measurement of the potential of the test cell.

5. The measurement device of claim 4, wherein the resistor comprises a variable resistor configured to vary the current used to measure the potential of the test cell.

6. The measurement device of claim 4, further comprising:
a third op amp configured to receive a signal from the second op amp;
a second resistor and a third resistor configured to generate a potential using the signal for the test cell to allow measurement of the current of the test cell.

7. The measurement device of claim 1, further comprising a power source configured to provide power the wireless transceiver and the circuit.

8. The measurement device of claim 1, wherein the wireless transceiver comprises a digital to analog converter (DAC) configured to provide the signal of a current value for achieving the potential.

9. The measurement device of claim 1, wherein the wireless transceiver comprises an analog to digital converter (ADC) configured to measure the current of the test cell.

10. The measurement device of claim 1, wherein the wireless transceiver receives second configuration information, the wireless transceiver outputting a second signal for use in measuring a second potential or second current based on the second configuration information.

11. The measurement device of claim 10, wherein the circuit is configured to receive the second signal and achieve a second desired current or second potential using the second signal, wherein a second potential or second current of the test cell is measurable using the current or potential.

12. The measurement device of claim 1, wherein the wireless measurement device is included in a sealed object, wherein the wireless transceiver communicates the measured potential or current to the second wireless transceiver that is outside of the sealed object.

13. A system comprising:
a first wireless transceiver configured to communicate with a base station through a wireless medium to receive configuration information, the wireless transceiver outputting a signal for use in measuring a potential or current based on the configuration information; and
a circuit configured to receive the signal and achieve a desired current or potential using the signal, wherein a potential or current of a test cell is measurable using the current or potential,
a second wireless transceiver configured to receive the potential or current measured from the first wireless transceiver through the wireless medium.

14. The system of claim 13, further comprising a computer configured to store the potential or current measured received at the second wireless transceiver.

15. The system of claim 14, wherein the computer is configured to send the configuration information to the first wireless transceiver to control the signal outputted by the first wireless transceiver thereby controlling the desired current or potential achieved.

16. The system of claim 14, wherein the computer is configured to send second configuration information to the first wireless transceiver to control the signal outputted by the first wireless transceiver thereby controlling a second desired current or second potential achieved.

17. The system of claim 14, further comprising a plurality of wireless transceivers coupled to the computer, the plurality of wireless transceivers configured to send potential or current measurements for a plurality of test cells to the computer.

18. The system of claim 17, wherein a mesh network is formed using the plurality of wireless transceivers.

19. The system of claim 13, wherein the computer receives input regarding a current or potential to achieve.

20. The system of claim 13, wherein the first wireless transceiver and the circuit are included in a sealed object, wherein the first wireless transceiver communicates the measured potential or current to the second wireless transceiver that is outside of the sealed object.
